(19) United States
(12) Patent Application Publication
(10) Pub. No.: US 2003/0154386 A1
(43) Pub. Date: Aug. 14, 2003

(54) Device for access-protected processing of electronic data

(76) Inventor: Erland Wittkotter, Buende (DE)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/212,952

(22) Filed: Aug. 6, 2002

Related U.S. Application Data
(63) Continuation of application No. PCT/EP01/01538, filed on Feb. 12, 2001.

(51) Int. Cl. G06F 12/14

(52) U.S. Cl. 713/193

(57) ABSTRACT

The invention relates to a device for access-protected processing of electronic data. The inventive device consists of an electronic data processing device, particularly a PC, with means of acquiring electronic data of a first electronic document and of retaining the data in an allocated volatile or permanent storage unit. The first electronic document has a predetermined document-specific data format involving a plurality of electronic streams linked by means of a tree, network, database and/or folder structure. By means of a display of the data processing device these streams can be read and displayed to the user as the first electronic document. At least one stream is suitable for having embedded and/or attached hidden data that cannot be discerned by the user when the display unit shows the document and can be retained, together with the first electronic document, in the storage unit. Means are provided of acquiring electronic data of a second electronic document that is at least partially protected against unauthorized access. Means are provided of embedding and/or attaching the protected data of the second electronic document in/to at least one stream as hidden data. Means are provided of extracting the data of the second electronic document from at least one stream and displaying the second document to the user, whereby extraction is carried out as a result of a decryption or authorization signal.² ² Ditto

The present invention relates to a device for access-protected processing (eg storing/transmitting) of electronic data according to the Preamble of Claim 1.

Such a device can be implemented, particularly using a commercial data processing device (PC), whereby such a known data processing device is designed for acquiring electronic data of the first electronic document, for example a text file, and can store this electronic data in a conventional, allocated (local and/or remote) storage unit, for example a (volatile) working memory or permanent mass storage.

As electronic storage systems (hereinafter also called file systems) have advanced, data processing devices have developed from application-specific devices (ie for an application with an allocated specific storage unit) though to universal data processing devices, eg PCs, which allow a plurality of different applications to be run under a single operating system for a user, so that a (mass) storage unit allocated to this universal data processing device must store and keep accessible a plurality of different, application-specific electronic data formats.

In the context of the present invention the concept of the electronic document is to be understood in a wide sense, and, in addition to the electronic text document referred to as an example, particularly all common user applications in the form of electronic files, for example image, graphics, spreadsheet, video, audio, database, project, design, interactive animation, game or program code files are to be understood as “electronic files” in the sense of the present application.

Traditional file systems therefore usually consist of a tree structure, which (according to the different electronic documents) structures the electronic files and maps them in folders and subfolders.

With increasing integration of various applications to produce electronic documents with a multiplicity of different components (hereinafter also called objects), such as image, graphical, textual and musical information in a single electronic document, it has proven expedient to supplement the heavily structured file system so that the electronic document itself or the associated file is now also given a tree or folder structure, with which individual data streams can be interlinked. With regard to both efficient storage management and the capability of representation of such an electronic document with a plurality of different objects, the tree and folder structure has considerable advantages, since it is possible individually and separately to access the streams that can be reached via the tree and folder structure, to assign usage rights and to achieve access in different ways.

A practical implementation of this advanced electronic document structure has been achieved, for example by Microsoft in the Windows 95, 98, 2000 and NT (from Version 4.0) operating system in the form of the OLE technology used, which is based on Component Object Modules (COM) as a structured data storage technology.

The heart of this storage technology is the structured organization of an electronic document as, for example, data streams arranged in a tree and folder structure and—usually by means of suitable software (although there is basically nothing to rule out a hardware implementation) —addressed by means of generated pointers and filled, for example, with binary data.

However, with the increasing complexity of the applications and electronic documents produced by the user the need for effective access protection that can be easily used to prevent unauthorized use, in order to safeguard not only confidential data (such as financial information or passwords), but also copyright documents of value to their creator, which cannot be disseminated in an uncontrolled manner, but, for example, only on the basis of authorization and transaction procedures.

Current application programs, such as word processing solutions, accordingly provide known methods of encrypting and decrypting contents, which can be accessed by the user by entering a password. However, even the need to hand over the password, for example if the user changes, with the associated security and communication risks, is problematic here.

There are other methods of protecting access, taking, for example, the form of discrete (ie disassociated from an application program) encryption applications, which accordingly encrypt a conventionally created electronic document, so it is then stored with local protection (ie in a data storage unit of a particular local computer system) or can be transmitted over electronic data networks (such as the Internet).

In addition to often being user unfriendly (which can put even authorized persons off decrypting a conventionally encrypted document) the known approaches also have the disadvantage that it always remains evident to the operator of the electronic data processing unit whether the electronic document involved is in encrypted form (in which case it either cannot be displayed at all, or use of the associated display unit, for example a word processing program, gives a completely meaningless string of characters), or the said document is not encrypted and therefore—potentially infringing copyright—can be copied and transmitted at will.

The invention starts from the existing solutions for access protection of electronic documents with these problems; its object, particularly in the case of complex user-specific electronic documents with a plurality of different application objects, is to improve the protection against unauthorized access and especially to make practical handling of access-protected, encrypted document technology simpler and therefore more readily accepted by the user.

The object is achieved with the device with the features defined by Claim 1.

In an advantageous manner according to the invention, the means of embedding and/or attaching the data of the second electronic document to be protected against unauthorized access act so that this data is linked (for embedding or attaching) with the electronic file belonging to the first electronic document, so that, when the electronic document is shown by an associated display unit (such as a word processing program) the user cannot see, discern or acquire the additional electronic data of the second electronic document, but it can be stored and transmitted together with the data of the first electronic document. The result is that the obtained files (ie data of the second file attached to and/or embedded in the first file) usually contain more data than before the encryption, and the hidden data is not completely (ie at byte level or below) defragmented.

The means provided can then be used to extract the data of the second electronic document as a result of a decryption or authorization signal, so that the second electronic document is then also available to the user for display (either by means of the same display unit as used for the first electronic document, or a different, specific display unit).

With the present invention, from the user's viewpoint both the first and the second electronic document have meaningful contents and are usable documents, such as texts, images, audio and/or video files, etc, and particularly also combinations of these, the present invention being particularly applicable to the case in which the first electronic file has inconspicuous contents that need no protection and attracts little attention, whereas the contents that actually need protection are hidden in the second electronic file. In particular, the second electronic file can even be identical to the first, the subsections that need to be kept secret then being arranged as hidden data in the same file, but in the data stream provided for embedding or attachment.

In contrast with the prior art, in this respect the present invention is advantageously characterized by the fact that the second electronic document, which is to be protected, is embedded in the data of the first electronic document, and cannot be discerned by the user when using the display unit, so that any attempts at decryption (to extract the second electronic file with restricted access) are countered by the very fact that this form of encryption cannot be recognized at all by an unauthorized person.

Moreover, the fact that ideally no password at all is used eliminates the associated risks; rather the processes connected with identification and authentication can be performed by, for example, the operating system itself.

Further advantageous embodiments of the invention are described in the dependent claims; thus as in the implementation of the present invention it has proven useful to embed in data streams (such as comments fields, fields for macro commands or control and script languages, which are usually already present within an electronic document structure and can be readily used yet are not shown to a user for display during regular document access) electronic data of the second electronic document to protect this data against unauthorized access. In addition or alternatively it is of course also possible to use the binary data streams outside the document-specific pointer addressing during regular read accessing, in order to attach or embed the data, eg by attaching an additional binary data stream to a stream (which cannot be addressed/jumped to through the logic of the display unit) already present in the particular tree and folder structure. In displaying the first electronic document (together with the access-protected second document), the display unit would then access the first electronic document's binary data stream for document display only with a pointer position defined during document creation, and the other attached binary data would be ignored during display or reproduction, but with the invention would necessary be stored and hence transmittable with the electronic document.

According to its own specific pointer position the means of extraction would then specifically access the attached binary data stream with the data of the second electronic document.

Particularly when script or macro languages or comments fields are used to embed the data of the second electronic document to be protected against unauthorized access, the activation of application or programming units (such as a macro, script or special comment entry field for a word processing program) provided specifically for this does of course allow the user to display the data of the second electronic document in this way (even if this is of course not to be understood as displaying by or functionality of the display unit in the sense of the present invention). Hence if the limited protection that can be achieved through this is not sufficient, a particularly preferred development of the present invention envisages additional encryption of this embedded information as well, for example by manipulating the data elements on a binary basis, or by using “semantic” encryption as explained in Dependent Claim 12 and forming the subject of earlier patent applications by the Applicant, for example in German Patent Applications 199 32 703.2 and 199 53 055.6 as a method of encrypting an electronically stored original quantity of data. The whole of the said applications' description of the generation of the code and of the decryption should be considered to pertain to the invention in the present description of the application.

The code or codes (code file) generated in the case of additional encryption of the embedded or attached data of the second electronic document can then itself or themselves be accommodated in another, suitable position in the electronic document and preferably be activated by linking instructions to be introduced from outside, particularly via an electronic data network, in order to decrypt and possibly extract the data of the electronic document; or alternatively it is possible to introduce such a code file via another (third) electronic document that preferably also does not allow a user using the usual display for the application to discern whether additional electronic data, namely a code file in this case, has been attached to or embedded in this document. There is also a particular preference for providing a plurality of codes or quantities of code data, not all of which lead to the same (correct) decryption result, some even yielding results that in turn are wrong (although this cannot be discerned by an unauthorized person). The technology protected in this regard by the Applicant under Application Number 199 62 902.1 applies to the extent that it is included in the present disclosure.

Another favorable embodiment of the invention uses the means of embedding and/or attaching to embed—in addition to the hidden data—other data, particularly data that is useless and/or does not need protection. This measure makes it even more difficult to discern and decrypt the data to be hidden.

One of the main objects of the present invention is to allow simple and convenient yet secure, access-protected transmission of electronic documents, prompting recipients of such a document to gain access to the protected document in response to a predetermined identification, authorization and/or payment dialog. This can be achieved in a particularly elegant way through the fact that although the first electronic document shown by the display unit in the usual manner for the application does not itself contain any references to the second electronic embedded in it or attached to it, the display unit can provide means of activation or switching, which allow the user to initiate such an authorization or payment dialog, whereupon, after identification or payment, access to the embedded or attached second electronic document is then enabled.

In a manner preferred according to the invention, this identification, authorization and/or payment dialog takes place with the use via an electronic data network, particularly the Internet, of an externally accessible host, which to this extent can then carry out effective access and copyright management (the function can of course also be implemented locally, eg though another user process).

As a result the present invention opens up a new way of storing and transmitting sensitive electronic documents inconspicuously and with access protection, particularly in a multimedia or electronic multiobject environment.

Further advantages, features and details of the invention are evident from the following description of a preferred exemplary embodiment and with reference to the diagrams, which show the following:

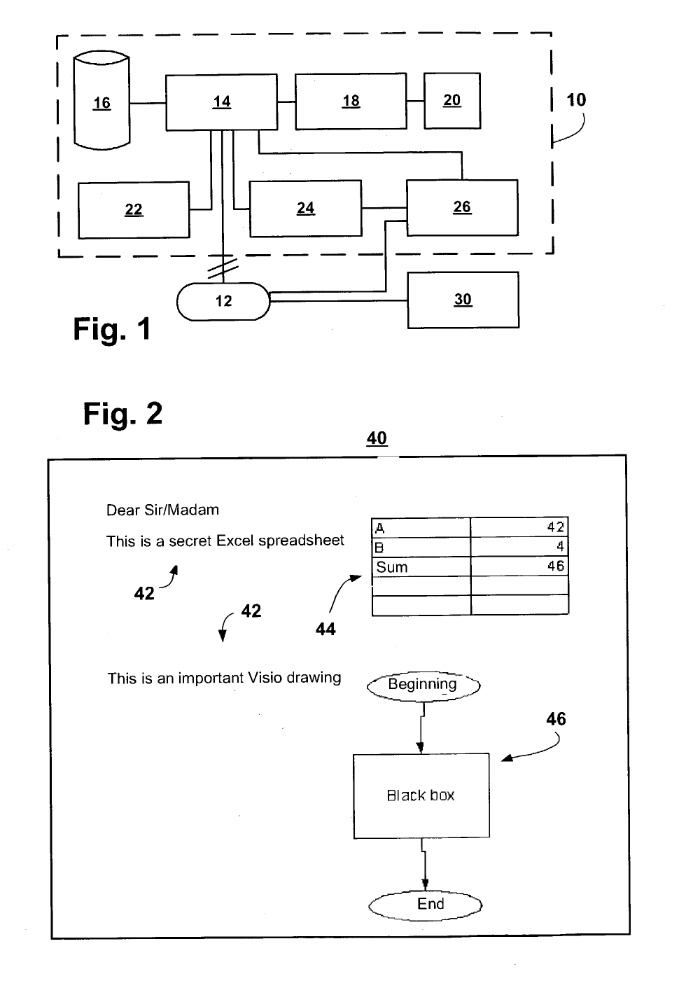

FIG. 1: Block diagram showing the principle of a first, preferred embodiment of the present invention;

FIG. 2: A view of a secret document to be protected against unauthorized access, which is shown by means of the display unit;

FIG. 3: A view of a tree or folder structure with the structured arrangement of the data streams of the document according to FIG. 2;

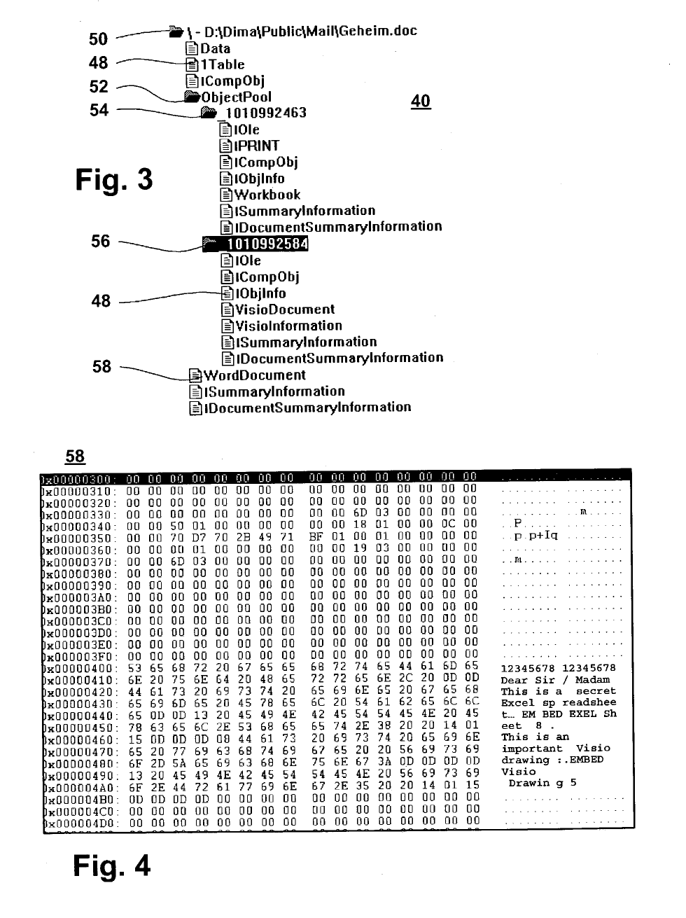

FIG. 4: A view of the binary data contained in a data stream of FIG. 3;

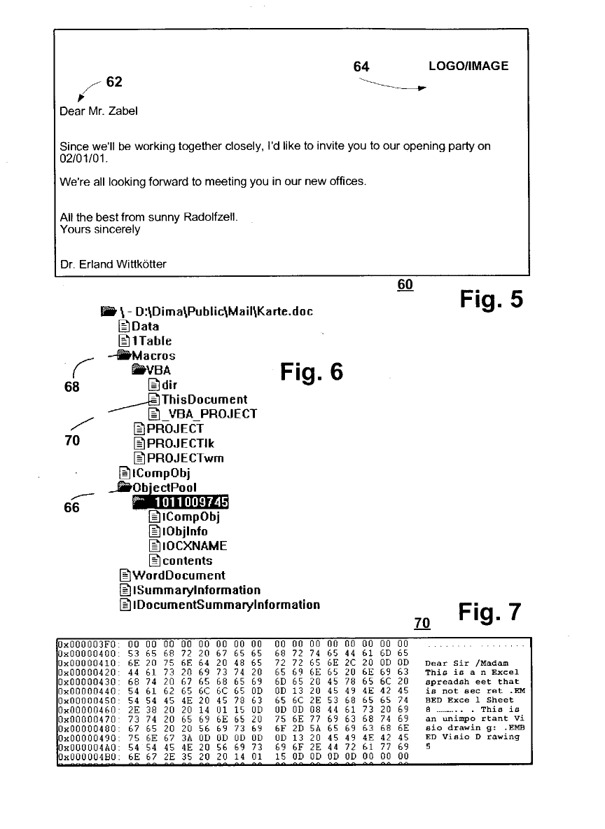

FIG. 5: A display, obtained with the display unit, of an electronic document with content that does not need protection and secret embedded document (according to FIG. 2) that cannot be discerned by the user;

FIG. 6: A tree or folder structure with data streams of the electronic document of FIG. 5;

FIG. 7: A view of a data stream of the document of FIG. 5 and of the structure of FIG. 6 and

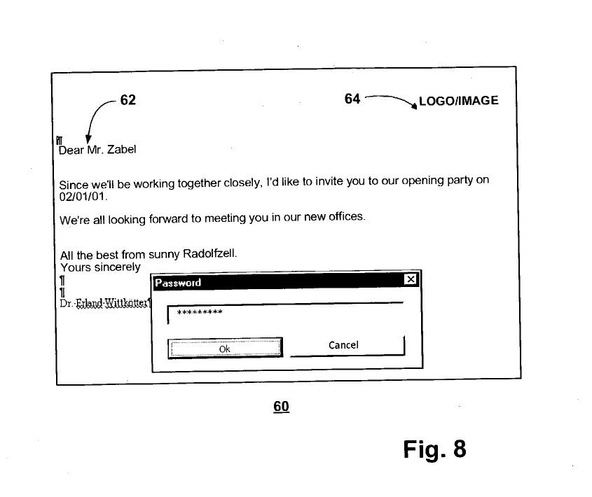

FIG. 8: A view of the electronic document according to FIG. 5 with activated password dialog for starting an authorization for a decryption.

FIG. 1 is a block diagram showing the design of a device for access-protected processing of electronic data according to a first embodiment of the invention, and taking the form of a commercial PC as electronic data processing device, which in otherwise known manner has a central processing unit 14, an allocated storage unit 16 in the form of a working memory and mass storage, and a display unit 18 in the form of a commercial application component for text and image processing with subsequent display unit 20 (eg a screen). Using an electronic data network 12 shown symbolically, the local unit 10 enclosed within a dashed line of FIG. 1 can be connected to an external host 30, whereby in a particularly preferred manner the data transmission network 12 consists of a public data network, eg the Internet.

In addition to commercial PC functionality the local unit 10 according to the shown embodiment and as shown in FIG. 1 also has an encryption unit 22 for embedding or attaching according to the invention data to be protected in another document, as well as a decryption unit for extracting the hidden or encrypted data and allowing the hidden document to be displayed, and a payment interface 26, which links the decryption or extraction by unit 24 with an authorization or payment dialog (which, as shown in FIG. 1, can be carried out particularly via the access to the data transmission network 12) with the external host 30.

With reference to FIGS. 2 to 8, a concrete example of access-protected processing of an electronic file by means of the device according to FIG. 1 will now be explained.

FIG. 2 shows a view of a secret, confidential document 40 to be protected against access, as produced, for example, with the display unit 18 designed as a word processing program with associated hardware for possible output to the screen unit 20. The said secret electronic document 40 consists of text data, a spreadsheet 44 and drawing data 46.

The secret electronic document 40 shown in FIG. 2 in the form it is normally reproduced by the display unit 18 has the data format of component object modules, as implemented by, for example, Microsoft using its proprietary OLE technology in current versions of the Windows operating system. FIG. 3 shows the folder and stream structure of the document to be displayed according to FIG. 2: as shown in the structured view of the form of the data of FIG. 3, the electronic document 40 called “geheim.doc” (“secret.doc”) consists of a plurality of electronic data streams 48, as symbolized by the page icons in the representation of FIG. 2. In the hierarchical tree structure that can be recognized in FIG. 3, these data streams are split into folders 50, each of which contains a plurality of streams 48 and possible further hierarchical folders 50 (possibly with further allocated streams).

Specifically, therefore, FIG. 3 show the structured form of data of a text file produced using Microsoft Word, which, using a folder 52 called ObjectPool and hierarchical subfolders 54 and 56, contains data streams for structure and contents of the spreadsheet 44 (in folder 54) and of the drawing 46 (in folder 56).

The secret electronic document 40 whose structure is shown in FIG. 3 can be assembled and accessed in otherwise known manner using the display unit 18, by means of otherwise known routines specific to the operating systems. The text data 42 (FIG. 2) is therefore displayed by accessing an electronic data stream 58 (Word document), which, as shown in the extract in FIG. 4, has hexconverted binary data and the textual information 42 in the binary sequence of the data stream 58.

With the device shown in FIG. 1, it is now possible to insert, embed or attach the secret electronic document 40 explained with reference to FIGS. 2 to 4 in or to another electronic document (hereinafter described as open electronic document 60), so that the—confidential—contents of secret document 40 cannot be discerned in the display of the open electronic document 60.

The open electronic document 60 used for the purposes of this encryption operation is shown in FIG. 5. It is a (harmless) invitation letter containing text data 62 and a graphic 64 embedded in the text.

Like FIG. 3, the open electronic document shown in FIG. 5 (by means of the display unit 18) is also assembled in a structured data format to the COM standard; a view of the structured data format for document 60 is shown in FIG. 6. Here again different data streams are organized with a hierarchy of folders, whereby in addition to an ObjectPool folder 66, which accommodates graphics data 64, a macro folder 68 with the structured data format of the open electronic document 60 (Karte.doc) is shown. In this macro folder in the present exemplary embodiment program code information for storing and executing predetermined automatic operations of the allocated display unit 18 in a predetermined macro or script language (in the present example the Visual Basic normally used in Microsoft environments) is stored. As is generally known, command words or data present in this way are part of document 60, but are cannot be seen or discerned by a user in the display of an electronic document (as, for example, in FIG. 5).

In the present exemplary embodiment of the invention, this macro stream allocated to the folder 68 (which is in fact provided to take the data of VBA macro commands, again in a binary data structure) is now used to take the text data 42, the spreadsheet data 44 and the drawing data 46 of the secret electronic document 40. To be more precise, the textual information 42 shown in FIG. 4 as binary data is embedded in the manner shown in FIG. 7, again as a bit data stream in a stream 70 below the macro folder 60, and, since these data streams are streams of electronic document 60 that cannot be displayed or are not intended for displaying, the reproduction or displaying of document 60 linked in this way does not change from the display of FIG. 5; rather the embedded or attached data hidden in the manner described remains concealed.

Since, however, for example through the hex-binary conversion form of representation used in FIGS. 4 and 7, unauthorized access to the structured data format of FIG. 6 could nevertheless be gained with suitable technical means to make the contents of the secret electronic document 40, through individually hidden, visible, the text data 42, as can be recognized by comparing FIGS. 4 and 7, is also additionally (semantically) encrypted: exchanging or replacement being used to give the original text data (wording: “This is a secret Excel spreadsheet . . . , This is an important Visio drawing”) a different lexical content (new content: “This is an Excel spreadsheet that is not secret . . . , This is an unimportant Visio drawing . . .”). As is easily recognized from the shown example, this encryption produces a form of the encrypted contents (which results in them being unusable for the unauthorized person gaining access) without it being evident to this person that the present encrypted text (FIG. 7) is actually something encrypted.

This encryption technology, which is protected for the applicant in German Patent Application 199 32 703.2, is based on semantic preparation of the texts with alternative words or texts that are meaningful or equivalent in terms of contents, and the operations of exchanging or replacement, insertion and removal of text components and words are carried out in a semantically meaningful context to provide encryption. At the same time a reconstruction instruction or code table necessary to obtain the original form (FIG. 4) is produced.

In the described exemplary embodiment the preferred development of the invention taking the form of semantic encryption of embedded or attached data to be hidden can be implemented in particularly preferred manner using the macro instructions provided in folder 68 themselves; as can embedding or extraction of the functionalities of the units 22, 24 (FIG. 1). Alternatively or in addition it is also possible to provide as a component of electronic document 60 its own object folder in ObjectPool 66, with which the described operations for embedding document data to be hidden or for the further encryption itself, particularly in the described semantic manner, can be carried out for a specific application.

In response to a password or authorization or payment dialog (FIG. 8), the described exemplary embodiment then provides for the possibility of making the hidden electronic document 40 available again in unencrypted form to a suitably authorized user. To achieve this a user operates a suitable (eg software implemented) switch, which is allocated to the displaying of images 64 in document 60, and in response a password entry box shown in FIG. 8 appears. As soon as an authorized user enters a correct password, in the described embodiment of the invention the secret electronic document 40 is reconstructed, initially by means of semantic decryption of the text data 42 contained in data stream 70 (FIG. 6) (whereby the associated decryption file and the reconstruction instruction are stored in a different, hidden location in a data stream), and, after the correct reconstruction of the text data, the spreadsheet data 44 and the drawing data 46 are then extracted as a secret electronic document to be displayed in the manner shown in FIG. 2 through the effect of suitable macro commands.

As a result the decrypted secret electronic document shown in FIG. 2 is revealed again to the authorized user by means of the display unit 18, and it becomes clear from the previous description that confidential text data encrypted (ie embedded or attached) according to the invention can be transmitted together with the file used as host at will, without the unauthorized person being able to discern this fact.

As shown in FIG. 1, the password box 72 shown in FIG. 8 can also, for example in the case of a wrong or unknown password, lead to the initiation of an application and/or payment dialog (in the course of which the user then enters, for example, appropriate credit card information to pay for the subsequent right to use or view the secret electronic document 40), this procedure taking place particularly with the aid of the data transmission network 12 and the external host 30 as clearance and administration server for corresponding usage data, access rights, etc.

The present invention is not limited to the exemplary embodiment shown in FIG. 1 with its particular functionality. The invention particularly covers the transmission of any other electronic files—either with just one application or one object, or with a mix of these—in the described manner hidden in a host file, or itself being used as a host file.

The invention's scope particularly also includes hiding a file that has to be kept secret partially (eg by removing the date information that has to be kept secret and embedding it in a manner according to the invention) rather than completely (ie with all of the content and/or object components). One special form of this embodiment involves the first electronic document (ie the open or host document) according to the invention and the second electronic document, which is to be protected against unauthorized access, being identical, whereby only individual document components need to be kept secret and protected accordingly. In a manner irrelevant to the display these are then embedded in or attached to a data stream, reproduction or display of the (encrypted) documents produced in this way then leading to the user accordingly not being able to discern the hidden data when the documents are displayed.

Types of electronic document and (associated) display unit within the scope of the present invention include virtually all those that produce or display an electronic document of use to the user; in particular the present invention is not limited to objects such as images, texts or graphics. Moreover, the encryption of the hidden files provided in developments is not limited to the semantic encryption described in the exemplary embodiment; other forms, particularly including classic encryption methods in the binary area, or mixed forms with semantic encryption, are conceivable. In addition the applicability of the present invention is not limited to electronic documents that, as shown in the exemplary embodiment, are hierarchically structured to the COM standard. Rather the present invention is suitable for all operating system environments that provide a document-specific data format from a plurality of electronic data streams, whereby in particular these can be also linked and structured in a network or in other ways, particularly using database techniques.

1. Device for access-protected processing of electronic data, with an electronic data processing device (10), particularly a PC, with
a means (14) of acquiring electronic data (62, 64) of a first electronic document (60) and of retaining the data in a volatile or permanent storage unit (16) allocated to the data processing device, whereby the first electronic document has a predetermined document-specific data format involving a plurality of electronic data streams linked by means of a tree, network, database and/or folder structure (66, 68, 70; 48-58),
the data streams along the tree, network, database and/or folder structure can be read and displayed to a user as the first electronic document (60) by means of a display unit (18, 20) of the data processing device
and at least one data stream (70) is suitable for having embedded and/or attached hidden data that cannot be discerned by the user when the display unit shows the document and can be retained together with the first electronic document in the storage unit,
characterized by means (14) of acquiring electronic data (42, 44, 46) of a second electronic document (40) that is to be at least partially protected against unauthorized access,
means (22) of embedding and/or attaching the data to be protected of the second electronic document in/to at least one stream (70) as hidden data and means (24) of extracting the data of the second electronic document from at least one stream and displaying the document to the user, whereby extraction is carried out as a result of a decryption or authorization signal.

2. Device according to claim 1, characterized in that the data stream (70) is a physically or virtually coherent storage area in the storage unit, which has a predetermined length and can be addressed by means of a pointer that can be implemented as software.

3. Device according to claim 1, characterized in that the stream is provided for filling with binary data.

4. Device according to one of claims 1, characterized in that the data stream has a field for comments, a macro command field and/or a field for a control or script language.

5. Device according to one of claims 1, characterized in that the predetermined document-specific format is a cross-application data format defined by an operating system within an operating system environment.

6. Device according to claim 5, characterized in that the predetermined data format is based on Microsoft's component object modules (COM).

7. Device according to one of claims 1, characterized in that the first electronic document and/or the second electronic document is a text file, an image file, a program code file, an audio file, a video file, a 3D file, an animation file, a database file, a project design file, an interactive animation file, a game file or a multimedia file with a plurality of text, image, program code, audio, 3D, database, project design, game, animation and/or video objects, whereby particularly the first and second electronic document are identical.

8. Device according to one of claims 1, characterized by means (26) of generating or conducting an identification, authorization and/or payment dialog with the user and of producing the decryption and/or authorization signal as a result of a positive identification or authorization of the user or a payment made.

9. Device according to claim 8, characterized in that the means of generating an identification, authorization and/or payment dialog can be activated by a means of switching device (64) provided in the first electronic document.

10. Device according to one of claims 1, characterized in that the data of the second document in encrypted form is attached to or embedded in at least one data stream of the first electronic document.

11. Device according to claim 10, characterized in that the encrypted form is attached or embedded in binary data form.

12. Device according to claim 11, characterized in that the data of the second electronic document consists of sequence of information components of a metalanguage in the form of a script language, a numerical system or of information components from data elements (particularly image, audio or program information) arranged in a predetermined, standardized format structure
and the encrypted form can be implemented by exchanging and/or removing an information component from the sequence and/or adding an information component at a predetermined position in the sequence of information components and/or replacing an information component with one preferably not originally contained in the data
and by producing a quantity of code data with details of the exchanged, removed, added and/or replaced information components.

13. Device according to claim 12, characterized in that the quantity of code data is embedded in or attached to a data stream of a third electronic document with access protection as hidden data.

14. Device according to one of claims 10, characterized in that a plurality of codes or quantities of code data is provided, which can be made accessible to a user on a selective and preferred basis depending on user group, and/or which do not all lead to the same decryption result after decryption.

15. Device according to one of claims 1, characterized in that the display unit of an application is an office software suite, particularly Microsoft (MS) Office.

16. Device according to one of claims 1, characterized in that the means of embedding and/or attaching the data to be protected are also designed for embedding or attaching any additional data.

17. Device according to one of claims 1, characterized in that the means of extracting are developed to provide selective deletion of data of the stream and/or replacement of data of the stream with code data.
